(19) United States
(12) Patent Application Publication
(10) Pub. No.: US 2024/0267152 A1
(43) Pub. Date: Aug. 8, 2024

(54) SYSTEMS AND METHODS FOR DYNAMIC ADJUSTMENT OF A TARGET BLOCK ERROR RATE

(71) Applicant: Telefonaktiebolaget LM Ericsson (publ), Stockholm (SE)

(72) Inventors: Akram BIN SEDIQ, Kanata (CA); Aaron CALLARD, Kanata (CA)

(21) Appl. No.: 18/570,203

(22) PCT Filed: Jun. 15, 2021
(86) PCT No.: PCT/IB2021/055285

§ 371 Date: Dec. 14, 2023

(51) Int. Cl. H04L 1/00

(52) U.S. Cl. CPC H04L 1/0021; H04L 1/0003

(57) ABSTRACT

Systems and methods of the present disclosure are directed to a method performed by a network node. The method includes determining whether Physical Channel (PCH) blocking has occurred for consecutive Transmission Time Intervals (TTIs) on a cell controlled by the network node, wherein PCH blocking occurs when Wireless Communication Devices (WCD) served by the cell cannot be scheduled for transmission in the cell due to unavailability of PCH resources in one or more consecutive TTIs. The method includes adjusting a target Block Error Rate (BLER) for link adaptation for a plurality of WCDs served by the cell based on whether PCH blocking has occurred for the plurality of consecutive TTIs on the cell to obtain a modified target BLER for link adaptation for the plurality of WCDs served by the cell.

### TECHNICAL FIELD

The present disclosure relates generally to a method and a network node, for dynamic adjustment of a target block error rate in a wireless network.

### BACKGROUND

### Downlink and Uplink Transmission Scheduling

In conventional wireless networks (e.g., Long Term Evolution (LTE), New Radio (NR), etc.), a base station of the network schedules downlink and uplink transmissions to Wireless Communication Devices (WCDs) by transmitting Downlink Control Information (DCI) to a WCD using a Physical Downlink Control Channel (PDCCH). A DCI can be used to inform the WCD how to decode a downlink transmission scheduled to the WCD, as it includes information about the resources allocated to the WCD in the Physical Downlink Shared Channel (PDSCH), the type of modulation and/or coding that the WCD is to use for decoding the WCD downlink data carried in the PDSCH, etc.

Similarly, a DCI can be used to inform the WCD how to encode an uplink transmission scheduled for the WCD, as it includes information about the resources allocated to the WCD in the Physical Uplink Shared Channel (PUSCH), the type of modulation and coding that the WCD needs to use for encoding the WCD's uplink data, etc. If the WCD fails to decode the PDCCH, then the WCD will be unable to decode/encode the corresponding PDSCH/PUSCH carrying the WCD downlink/uplink data. Hence, PDCCH are generally dimensioned to be more reliable in comparison to PDSCH and PUSCH.

### Target Block Error Rate

Block Error Rate (BLER) is a measurement of quality for wireless network transmissions and is conventionally defined as a number of erroneous transmission blocks divided by a total number of received transmission blocks. A transmission block is generally found to be erroneous if the transmission block fails a Cyclic Redundancy Check (CRC). Different target BLERs are typically set for different types of physical channels and, as described below, used to perform link adaptation for the respective channels. To follow the previous example, as unsuccessfully decoding PDCCH is more “costly” than unsuccessfully decoding PDSCH and/or PUSCH, the target BLER for PDCCH may be set to, e.g., 1% while the target BLER for PDSCH or a PUSCH may be set to, e.g., 10%. Various techniques can be used to adjust parameters (e.g., the modulation and coding scheme and/or transmission power) to achieve the target BLER for PDCCH/PDSCH/PUSCH.

### Link Adaptation

Link Adaptation (LA) is one example of a technique used to adjust one or more parameters (e.g., modulation and coding scheme and/or transmission power) to achieve the target BLER for PDCCH, PDSCH, and PUSCH. For instance, in a conventional base station, PDCCH LA is used to adapt the modulation or coding scheme (e.g., amount of redundant bits, etc.) and/or the transmission power according to the channel conditions of the intended WCD such that the target BLER for PDCCH is achieved. As an example, a WCD with favorable channel conditions would need less redundant bits for channel protection, and thus will require less radio resources. As another example, the transmission power of a WCD with favorable channel conditions can be reduced, which in turn reduces the interference in other cells. Link adaptation of these channel parameters is performed by using channel state information reports received from the WCD together with an outer control loop. The outer control loop is configured to utilize past success and failure information for PDCCH decoding at the WCD (e.g., Hybrid Automatic Repeat Request (HARQ) Acknowledgments (ACKs)/Negative Acknowledgments (NACKs)) to determine an estimate of the WCD's channel quality.

For the PDCCH, setting the target BLER for PDCCH to lower values leads to more reliable PDCCH decoding at the WCD at the expense of using more redundancy bits. This increase in redundancy bits consumes more PDCCH resources, which reduces the number of WCDs that can be scheduled in a given Transmission Time Interval (TTI). Conversely, setting the PDCCH target BLER to higher values uses less redundancy bits, which consumes fewer PDCCH resources and therefore increases the number of WCDs that can be scheduled in a given TTI. However, raising the PDCCH target BLER to a higher value also leads to less reliable PDCCH decoding. Both the reliability of PDCCH decoding and the number of users that can be scheduled in a given TTI are key objectives for wireless network performance, and as such, optimizing the target BLER is of the utmost importance for network performance.

### SUMMARY

Systems and methods are disclosed herein for dynamic adjustment of a target Block Error Rate (BLER) used for Link Adaptation in a cell of a cellular communications system. One example aspect of the present disclosure is directed to a method performed by a network node for dynamic adjustment of a target BLER. In one embodiment, the method includes determining whether Physical Channel (PCH) blocking has occurred for a plurality of consecutive Transmission Time Intervals (TTIs) on a cell controlled by the network node. The PCH blocking occurs when one or more Wireless Communication Devices (WCDs) served by the cell cannot be scheduled for transmission in the cell due to unavailability of PCH resources in one or more consecutive TTIs. The method includes adjusting a target BLER for link adaptation for a plurality of WCDs served by the cell based on whether PCH blocking has occurred for the plurality of consecutive TTIs on the cell to obtain a modified target BLER for link adaptation for the plurality of WCDs served by the cell. By adjusting the target BLER based on PCH blocking occurrence, rather than setting a static target BLER, link adaptation for the cell can be dynamically influenced to substantially increase network performance and efficiency.

In one embodiment, PCH blocking occurs when one or more WCDs served by the cell cannot be scheduled for transmission in the cell due to unavailability of PCH resources in a single TTI. Determining whether PCH blocking has occurred for the plurality of consecutive TTIs on the cell includes determining whether PCH blocking has occurred for each TTI of the plurality of consecutive TTIs.

In one embodiment, PCH blocking occurs when one or more WCDs served by the cell cannot be scheduled for transmission in the cell due to unavailability of PCH resources in a particular set of PCH resources in a single TTI. Determining whether PCH blocking has occurred for the plurality of TTIs on the cell comprises determining whether PCH blocking has occurred for each TTI of the plurality of consecutive TTIs.

In one embodiment, PCH blocking occurs when one or more WCDs served by the cell cannot be scheduled for transmission in the cell due to unavailability of PCH resources in N consecutive TTIs. Determining whether PCH blocking has occurred for the plurality of TTIs on the cell comprises determining whether PCH blocking has occurred for one or more sets of N consecutive TTIs from among the plurality of consecutive TTIs. N is an integer that is greater than or equal to 2.

In one embodiment, PCH blocking occurs when one or more WCDs served by the cell cannot be scheduled for transmission in the cell due to unavailability of PCH resources in a given set of PCH resources in N consecutive TTIs. Determining whether PCH blocking has occurred for the plurality of TTIs on the cell comprises determining whether PCH blocking has occurred for one or more sets of N consecutive TTIs from among the plurality of consecutive TTIs, wherein N is an integer that is greater than or equal to 2.

In one embodiment, adjusting the target BLER used for link adaptation for the plurality of WCDs served by the cell includes making a determination that PCH blocking has not occurred for at least one of the plurality of consecutive TTIs, and, responsive to making the determination, reducing the target BLER by a predetermined downstep value to obtain the modified target BLER.

In one embodiment, adjusting the target BLER used for link adaptation for the plurality of WCDs served by the cell includes making a determination that PCH blocking has occurred in each of the plurality of consecutive TTIs, and increasing the target BLER by an upstep value to obtain the modified target BLER.

In one embodiment, the modified BLER is less than or equal to a maximum BLER and greater than or equal to a minimum BLER. In one embodiment, prior to increasing the BLER by the upstep value, the method further includes determining the upstep value based at least in part on:

$$\\ \frac{1 - a maximum blocking probility}{the maximum blocking probability} \times a predetermined downstep value$$

In one embodiment, adjusting the target BLER used for link adaptation for the plurality of WCDs served by the cell includes adjusting the target BLER every TTI of the plurality of TTIs.

In one embodiment, the method further includes performing, based at least in part on the modified target BLER, link adaptation for a PCH transmission on the cell to a particular WCD of the plurality of WCDs served by the cell. In one embodiment, performing the link adaptation for the PCH transmission on the cell to the particular WCD includes adjusting at least one of a modulation or coding scheme or a transmission power of the PCH transmission on the cell to the particular WCD based on the modified target BLER.

In one embodiment, the PCH blocking is either a Physical Uplink Shared Channel (PUSCH) blocking, a Physical Downlink Control Channel (PDCCH) blocking, or a Physical Downlink Shared Channel (PDSCH) blocking.

In one embodiment, adjusting the BLER for the link adaptation for the plurality of WCDs further includes modifying, for the cell controlled by the network node, a mapping between the plurality of WCDs served by the cell and one or more of Channel Quality Indicators (CQIs), Signal-to-Noise Ratios (SNRs), or Rank Indicators (RIs).

In one embodiment, adjusting the BLER for the link adaptation for the plurality of WCDs further includes transitioning the cell controlled by the network node from a first operating mode to a second operating mode. The first operating mode includes a first mapping between PCH resources and a first number of bits to be transmitted. The second operating mode includes a second mapping between the PCH resources and a second number of bits to be transmitted different than the first number of bits to be transmitted.

In one embodiment, adjusting the BLER for the link adaptation for the plurality of WCDs further includes adjusting a number of Control Channel Elements (CCEs) allocated to the PDCCH resources of the PCH resources.

Another example aspect of the present disclosure is directed to a network node for dynamic adjustment of a target BLER. In one embodiment, the network node is adapted to determine whether PCH blocking has occurred for a plurality of consecutive TTIs on the cell controlled by the network node. PCH blocking occurs when one or more WCDs served by the cell cannot be scheduled for transmission in the cell due to unavailability of PCH resources in one or more consecutive TTIs. The network node is adapted to adjust a target BLER for link adaptation for a plurality of WCDs served by the cell based on whether PCH blocking has occurred for the plurality of consecutive TTIs on the cell to obtain a modified target BLER for link adaptation for the plurality of WCDs served by the cell.

In another embodiment, the network node includes processing circuitry. The processing circuitry is configured to cause the network node to determine whether PCH blocking has occurred for a plurality of consecutive TTIs on the cell controlled by the network node. PCH blocking occurs when one or more WCDs served by the cell cannot be scheduled for transmission in the cell due to unavailability of PCH resources in one or more consecutive TTIs. The processing circuitry is configured to cause the network node to perform one or more optimization actions. The one or more optimization actions include adjusting a target BLER for link adaptation for a plurality of WCDs served by the cell based on whether PCH blocking has occurred for the plurality of consecutive TTIs on the cell to obtain a modified target BLER for link adaptation for the plurality of WCDs served by the cell. The one or more optimization actions include modifying, for the cell controlled by the network node, a mapping between the plurality of WCDs served by the cell and one or more of CQIs, SNRs, or RIs. The one or more optimization actions include transitioning the cell controlled by the network node from a first operating mode to a second operating mode. The first operating mode includes a first mapping between PCH resources and a first number of bits to be transmitted. The second operating mode includes a second mapping between the PCH resources and a second number of bits to be transmitted different than the first number of bits to be transmitted. The one or more optimization actions include adjusting a number of CCEs allocated to the PDCCH resources of the PCH resources.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates one example of a cellular communications system according to some embodiments of the present disclosure;

FIG. 2 illustrates the operation of a network node to optimize Physical Channel (PCH) resource allocation based on PCH blocking occurrence according to some embodiments of the present disclosure;

FIG. 3 is a flowchart illustrating a method implemented in a wireless network by a network node for adaptive adjustment of a target Block Error Rate (BLER) according to some embodiments of the present disclosure;

FIG. 4 is a flowchart illustrating a method for a network node to perform one or more optimization actions according to some embodiments of the present disclosure;

FIG. 5 is a schematic block diagram of a radio access node according to some embodiments of the present disclosure;

FIG. 6 is a schematic block diagram that illustrates a virtualized embodiment of the radio access node of FIG. 5 according to some embodiments of the present disclosure; and

FIG. 7 is a schematic block diagram of the radio access node of FIG. 5 according to some other embodiments of the present disclosure.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an Enhanced or Evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: a mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Transmission/Reception Point (TRP): In some embodiments, a TRP may be either a network node, a radio head, a spatial relation, or a Transmission Configuration Indicator (TCI) state. A TRP may be represented by a spatial relation or a TCI state in some embodiments. In some embodiments, a TRP may be using multiple TCI states. In some embodiments, a TRP may be a part of the gNB transmitting and receiving radio signals to/from a UE according to physical layer properties and parameters inherent to that element. In some embodiments, in Multiple TRP (multi-TRP) operation, a serving cell can schedule a UE from two TRPs, providing better Physical Downlink Shared Channel (PDSCH) coverage, reliability and/or data rates. There are two different operation modes for multi-TRP: single Downlink Control Information (DCI) and multi-DCI. For both modes, control of uplink and downlink operation is done by both physical layer and Medium Access Control (MAC). In single-DCI mode, a UE is scheduled by the same DCI for both TRPs and in multi-DCI mode, the UE is scheduled by independent DCIs from each TRP.

In some embodiments, a set Transmission Points (TPs) is a set of geographically co-located transmit antennas (e.g., an antenna array (with one or more antenna elements)) for one cell, part of one cell or one Positioning Reference Signal (PRS)-only TP. TPs can include base station (eNB) antennas, Remote Radio Heads (RRHs), a remote antenna of a base station, an antenna of a PRS-only TP, etc. One cell can be formed by one or multiple TPs. For a homogeneous deployment, each TP may correspond to one cell.

In some embodiments, a set of TRPs is a set of geographically co-located antennas (e.g., an antenna array (with one or more antenna elements)) supporting TP and/or Reception Point (RP) functionality.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

Physical Downlink Control Channel (PDCCH), Physical Downlink Shared Channel (PDSCH), and Physical Uplink Shared Channel (PUSCH) block error rate (BLER) targets in wireless networks are static parameters (e.g., 5%, 10%, 1%, etc.) that, conventionally, are prohibitively difficult to adapt in real-time, as both network traffic and network load are time-varying. As such, target BLERs are conventionally set as fixed values, where different target BLERs are typically defined for different types of physical channels (PCH) (e.g., 1% for PDCCH, 10% for PDSCH, etc.). However, without the capacity to adapt to changing network conditions, fixed target BLER values introduce a number of inefficiencies. As an example, in very low load conditions, a fixed-value target BLER cannot be decreased adaptively to allow for a greater number of redundant bits and therefore increase transmission accuracy. As another example, in very high load conditions, a fixed-value target BLER cannot be increased to allow for a greater number of users to be scheduled in a given Transmission Time Interval (TTI).

Systems and methods are disclosed herein that address the aforementioned and/or other problems associated with the conventional cellular communications system in which a static target BLER is used. Generally, systems and methods of the present disclosure are directed to a dynamic adjustment of a target BLER. As an example, a network node first determines whether a Physical Channel blocking has occurred for a plurality of consecutive TTIs on the cell controlled by the network node. PCH blocking occurs when one or more Wireless Communication Devices (WCDs) served by the cell cannot be scheduled for transmission in the cell due to unavailability of PCH resources, in one or more consecutive TTIs (e.g., PDCCHs, PDSCHs, Physical Uplink Control Channels (PUCCHs), etc.). Based at least in part on whether PCH blocking has occurred for the plurality of consecutive TTIs, a target BLER is adjusted to obtain a modified target BLER for link adaptation for a plurality of WCDs served by the cell.

More specifically, a load-aware control loop (e.g., a “grand” outer loop) for network node(s) is proposed for dynamic adjustment of a target BLER for PDCCH, PDSCH, and/or PUSCH (e.g., a target BLER for PDCCH, PDSCH, and/or PUSCH link adaptation). For example, the load-aware control loop will adjust the aggressiveness or conservativeness of a conventional outer loop of the network node when performing link adaptation. The load-aware control loop balances the need for high PCH capacity (e.g., to reduce the number of users who cannot be scheduled due to insufficient PCH resources) against the need for successful decoding of the PCH resources. In turn, this causes the number of PCH resources assigned to each user to increase in the conditions of low blocking occurrence, and to decrease in conditions of high blocking occurrence. As such, in one embodiment, the target BLER is dynamically adjusted such that a PCH blocking probability in a given TTI is less than or equal to a configurable threshold.

Systems and methods of the present disclosure provide a number of technical effects and benefits. As one example of technical effect and benefit, example embodiments of the present disclosure facilitate adaptive adjustment of a target BLER at the cell level for a network node. As described previously, conventional techniques generally set a static BLER value (e.g., 1% for PDCCH, 10% for PDSCH, etc.). However, by adjusting a target BLER based on PCH blocking occurrence on a cell, a modified target BLER can be obtained adaptively for subsequent link adaptation for WCDs served by the cell. Unlike static BLER values, dynamic adjustment of a target BLER exploits the time-varying nature of traffic and WCD load at the cell of the network node to increase efficiency of the cell (e.g., the number of WCDs that can be scheduled in a given TTI in high-load circumstances) or to increase performance of the cell (e.g., transmission quality for WCDs served by the cell in low-load circumstances).

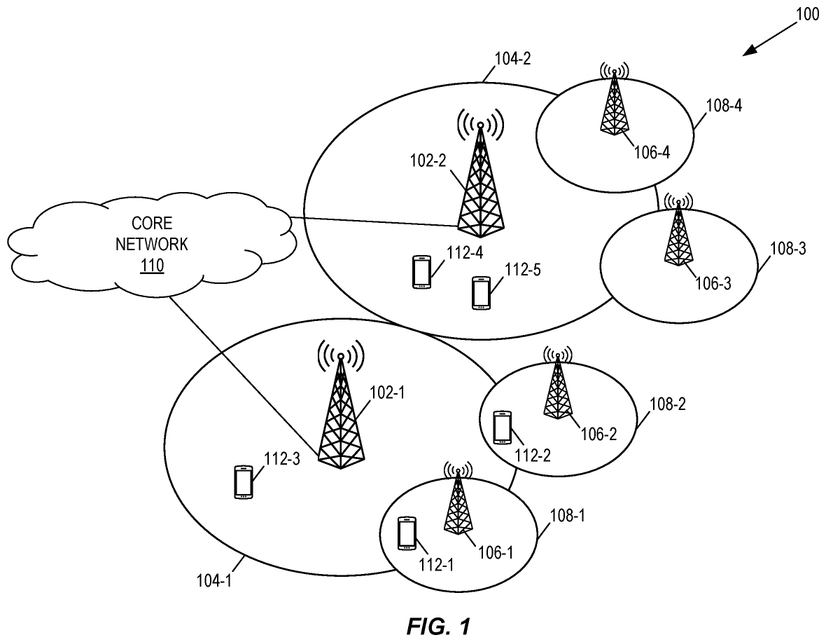

FIG. 1 illustrates one example of a cellular communications system 100 in which embodiments of the present disclosure may be implemented. In the embodiments described herein, the cellular communications system 100 is [a 5G system (5GS) including a Next Generation RAN (NG-RAN) and a 5G Core (5GC) or an Evolved Packet System (EPS) including an Evolved Universal Terrestrial RAN (E-UTRAN) and an Evolved Packet Core (EPC). In this example, the RAN includes base stations 102-1 and 102-2, which in the 5GS include gNBs and optionally next generation eNBs (ng-eNBs) (e.g., LTE RAN nodes connected to the 5GC) and in the EPS include eNBs, controlling corresponding (macro) cells 104-1 and 104-2. The base stations 102-1 and 102-2 are generally referred to herein collectively as base stations 102 and individually as base station 102. Likewise, the (macro) cells 104-1 and 104-2 are generally referred to herein collectively as (macro) cells 104 and individually as (macro) cell 104. The RAN may also include a number of low power nodes 106-1 through 106-4 controlling corresponding small cells 108-1 through 108-4. The low power nodes 106-1 through 106-4 can be small base stations (such as pico or femto base stations) or RRHs, or the like. Notably, while not illustrated, one or more of the small cells 108-1 through 108-4 may alternatively be provided by the base stations 102. The low power nodes 106-1 through 106-4 are generally referred to herein collectively as low power nodes 106 and individually as low power node 106. Likewise, the small cells 108-1 through 108-4 are generally referred to herein collectively as small cells 108 and individually as small cell 108. The cellular communications system 100 also includes a core network 110, which in the 5GS is referred to as the 5GC. The base stations 102 (and optionally the low power nodes 106) are connected to the core network 110.

The base stations 102 and the low power nodes 106 provide service to WCDs 112-1 through 112-5 in the corresponding cells 104 and 108. The wireless communication devices 112-1 through 112-5 are generally referred to herein collectively as wireless communication devices 112 and individually as wireless communication device 112. In the following description, the wireless communication devices 112 are oftentimes UEs, but the present disclosure is not limited thereto.

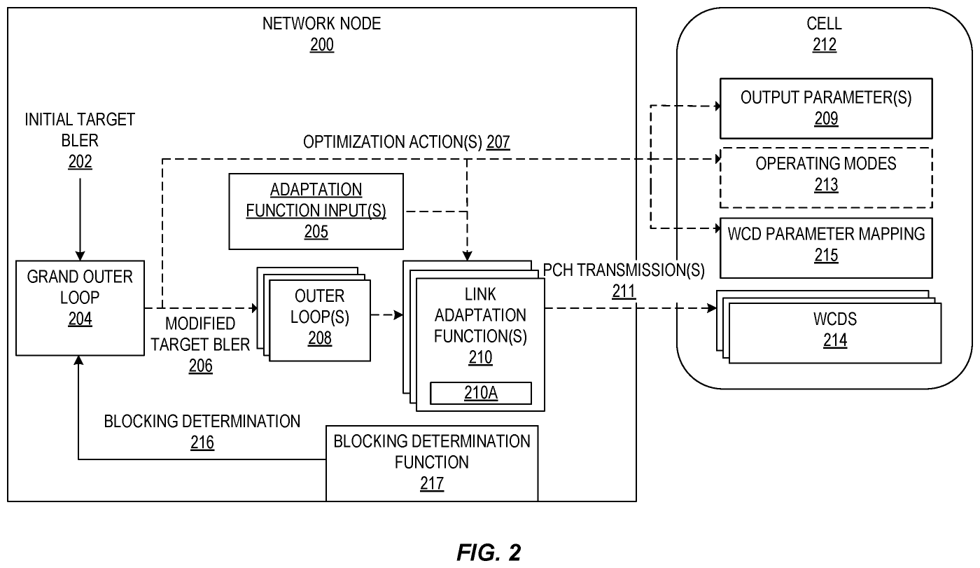

FIG. 2 illustrates a network node 200 that operates to dynamically adjust a target BLER for a PCH based on PCH blocking occurrence according to some embodiments of the present disclosure. The network node 200 may be a base station 102 or a network node that implements at least some of the functionality of the base station 102. As illustrated, the network node 200 has, either via pre-configuration or stored in memory, an initial target BLER 202 for a respective PCH (e.g., PDCCH, PDSCH, or PUSH) for a cell 212 served by, or controlled by, the network node 200. This initial target BLER 202 may be a static target BLER similar to the conventional target BLER. The network node 200 includes a grand outer loop 204 that operates to dynamically adjust the target BLER 202 to provide a modified target BLER 206 for the cell 212 for the respective PCH type. More specifically, the grand outer loop 204 is, includes, or is otherwise executed and/or processed by a controller of the network node 200 (e.g., an integral controller, a Proportional-Integral-Derivative (PID) controller, a virtualized controller, etc.). The grand outer loop 204 is configured to adjust the initial target BLER 202 for the cell 212 based on the occurrence of PCH blocking to thereby provide the modified target BLER 206 for the cell 212 for the respective PCH type. More particularly, the grand outer loop 204 can adjust the initial target BLER 202 based at least in part on a blocking determination 216 output by a blocking determination function 217 to obtain a modified target BLER 206.

Based on the blocking determination 216 output by the blocking determination function 217, the grand outer loop 204 adjusts the initial target BLER 202 to obtain the modified target BLER 206, which is then input to outer loops 208 that together with respective link adaptation function(s) 210 perform link adaptation for PCH transmissions (e.g., PUSCH transmission, PDSCH transmission, PUSCH transmission, etc.) for respective WCDs 214 on the cell 212. Note that the modified target BLER is a cell-level parameter used by the outer loops 208 for all of the WCDs 214. For each WCD 214, the respective outer loop 208 and link adaptation function 210 operate to adaptively control one or more PCH transmission related parameters (e.g., modulation and coding scheme, transmit power, etc.) such that the modified target BLER 206 is achieved. The grand outer loop 204 dynamically updates the modified target BLER 206 for the PCH for the cell 212 based on (updated) blocking determination 216 over time (e.g., periodically). Thus, for the first iteration, the initial target BLER 202 is modified by the grand outer loop 204 based on a first blocking determination (e.g., blocking determination 216) to provide a first modified target BLER (e.g., modified target BLER 208). Then, for the next iteration, the grand outer loop 204 further modifies the first modified target BLER 206 based on a second blocking determination to provide a second modified target BLER, and so on. In such fashion, the target BLER (e.g., the initial target BLER 202) for the PCH for the cell 212 is adaptively adjusted in an iterative manner.

It should be noted that the modified target BLER 206 is determined by the grand outer loop 204 at the cell level for use by the outer loop(s) 208. More particularly, the outer loop(s) 208 may include one or more outer loops for PCH transmission(s) 211 to one or more WCDs of the plurality of WCDs 214, respectively. Similarly, the link adaptation function(s) 210 may include one or more link adaptation functions for PCH transmission(s) 211 to one or more WCDs of the plurality of WCDs 214, respectively. As such, the grand outer loop 204 can determine the modified target BLER 206 for the cell 212 that serves the WCDs 214, and the outer loop(s) 208 together with the link adaptation function(s) 210 may adjust one or more PCH transmission related parameters (e.g., a modulation or coding scheme and/or a transmission power) used for PCH transmissions 211 on the cell 212 to the particular WCD(s) of the plurality of WCDs 214.

In addition to or as an alternative to modifying the target BLER based on the blocking determination 216, in some embodiments, the network node 200 may perform one or more optimization actions 207 based at least in part on the blocking determination 216. In one embodiment, the optimization action(s) 207 includes a cell-level optimization action(s) that modifies one or more parameters associated with the outer loop(s) 208 and/or the link adaptation function(s) 210 (e.g., cell-level modification of reported Channel Quality Indications (CQIs) reported by the WCDs 214, cell-level modification of rank reported by the WCDs 214, cell-level modification of Signal to Noise Ratio (SNR) estimates for the WCDs 214 used for link adaptation, or cell-level modification of one or more output parameters (e.g., number of Control Channel Elements (CCEs) for PDCCH) output by the link adaptation function(s) 210, etc.).

Thus, in one embodiment, the one or more parameters modified by the optimization action(s) include one or more input parameters. Input parameter(s) include, or are otherwise associated with, adaptation function input(s) 205 for the link adaptation function(s) 210 (e.g., a CQI parameter, a rank indicator (RI) parameter, etc.).

In one embodiment, the one or more parameters modified by the optimization action(s) 207 include one or more internal parameters Z110A. The internal parameter(s) Z110A are parameters included within, and/or associated with the functionality of, the link adaptation function(s) 210 (e.g., an estimated SNR, an estimated SNR generation function, etc.). As an example, the link adaptation function(s) 210 may internally generate an estimated SNR parameter (e.g., as an intermediate step, etc.). The estimated SNR parameter may be adjusted by applying an offset to the estimated SNR parameter.

In one embodiment, the one or more parameters modified by the optimization action(s) 207 include output parameter(s) 209. The output parameter(s) 209 are output(s) from the link adaptation function(s) 210 and/or are associated with the outputs of the link adaptation function(s) 210 (e.g., a decision output, a number of CCEs allocated to, PDCCH, resources of the PCH resources, etc.). For example, the output parameter(s) 209 can include a CCE/PDCCH mapping that maps a certain quantity of CCEs allocated to each PDCCH resource.

In another embodiment, the optimization action(s) 207 additionally, or alternatively, include transitioning the cell 212 from a first operating mode to a second operating mode of the operating modes 213 based at least in part on the blocking determination 216. As an example, the operating modes 213 may include a first mode for a level of network congestion that is at or below a low congestion threshold, and a second mode for level of network congestion at or above a high congestion threshold. Each of the operating modes 213 map a number of PCH resources to a WCD for a quantity of bits to be transmitted. For example, the first operating mode may map 4 PCH resources to a WCD for transmitting a quantity of bits, and the second operating mode may map 2 PCH resources to a WCD for transmitting the same quantity of bits.

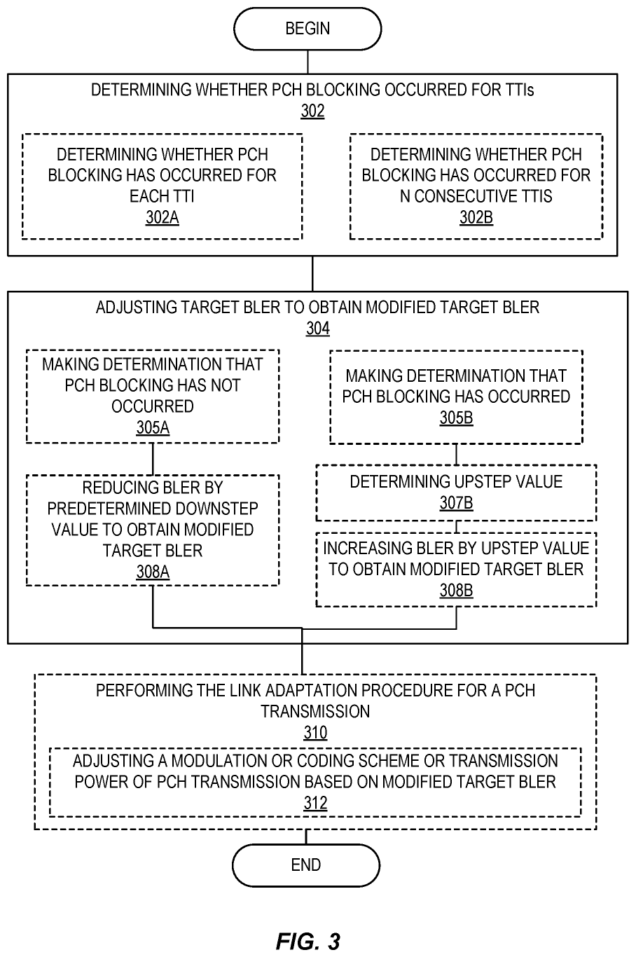

FIG. 3 is a flowchart illustrating a method performed by a network node according to some embodiments of the present disclosure. Optional steps are represented in FIG. 3 by dashed lines/boxes. In this example, the network node is the network node 200.

At step 302, the network node 200 determines whether PCH blocking occurred for a plurality of TTIs on the cell controlled by the network node 200. PCH blocking occurs when one or more WCDs served by the cell cannot be scheduled for transmission in the cell due to unavailability of PCH resources in one or more consecutive TTIs.

Optionally, at step 302A, the network node 200 determines whether PCH blocking has occurred by determining whether PCH blocking has occurred for each TTI of the plurality of consecutive TTIs. In one embodiment, PCH blocking occurs when one or more WCDs served by the cell cannot be scheduled for transmission in the cell due to unavailability of PCH resources in a single TTI. At step 302A, the network node 200 then optionally determines whether PCH blocking has occurred for each TTI of the plurality of consecutive TTIs.

In another embodiment, PCH blocking occurs when one or more WCDs served by the cell cannot be scheduled for transmission in the cell due to unavailability of PCH resources in a particular set of PCH resources in a single TTI. For example, PCH blocking may occur when a set of PDCCH resources in a particular set of PCH resources is unavailable in a single TTI. At step 302A, the network node 200 then optionally determines whether PCH blocking has occurred for each TTI of the plurality of consecutive TTIs.

Optionally, at step 302B, the network node 200 determines whether PCH blocking has occurred by determining whether PCH blocking has occurred for one or more sets of N consecutive TTIs from among the plurality of consecutive TTIs, and N is an integer that is greater than 2. In one embodiment, PCH blocking occurs when one or more WCDs served by the cell cannot be scheduled for transmission in the cell due to unavailability of PCH resources in N consecutive TTIs. At step 302B, the network node 200 then optionally determines whether PCH blocking has occurred by determining whether PCH blocking has occurred for one or more sets of N consecutive TTIs from among the plurality of consecutive TTIs, and N is an integer that is greater than 2.

In another embodiment, PCH blocking occurs when one or more WCDs served by the cell cannot be scheduled for transmission in the cell due to unavailability of PCH resources in a given set of PCH resources in N consecutive TTIs. At step 202B, the network node 200 then optionally determines whether PCH blocking has occurred for one or more sets of N consecutive TTIs from among the plurality of consecutive TTIs, and N is an integer that is greater than or equal to 2.

In some embodiments, PCH blocking includes either PUSCH blocking, PDCCH blocking, or PDSCH blocking.

At step 304, the network node 200 adjusts a target BLER to obtain a modified target BLER 304 based at least in part on whether PCH blocking has occurred. More particularly, the network node 200 adjusts a target BLER for the link adaptation for a plurality of WCDs served by the cell to obtain a modified target BLER for the link adaptation for a plurality of WCDs served by the cell (e.g., a link adaptation procedure to modify characteristics of transmissions to WCD(s) served by the cell, etc.).

At step 305A, to adjust the target BLER to obtain the modified target BLER, the network node 200, optionally, makes a determination that PCH blocking has not occurred for at least one of the plurality of consecutive TTIs. Responsive to making the determination at step 305A, the network node 200, optionally, reduces the target BLER by a predetermined downstep value to obtain the modified target BLER.

Alternatively, at step 305B, to adjust the target BLER to obtain the modified target BLER, the network node 200, optionally, makes a determination that PCH blocking has occurred in each of the plurality of consecutive TTIs. At step 307B, the network node 200, optionally, determines an upstep value. In one embodiment, the network node 200 determines the upstep value based at least in part on:

$$\\ \frac{1 - a maximum blocking probility}{the maximum blocking probability} \times a predetermined downstep value$$

At step 308B, responsive to making the determination at step 305B, the network node 200, optionally, increases the target BLER by the upstep value to obtain the modified target BLER.

In one embodiment, the modified target BLER is less than or equal to a maximum BLER, and is greater than or equal to a minimum BLER.

In one embodiment, at step 304, a grand outer loop of the network node 200 adjusts the target BLER to obtain the modified target BLER. As an example, to adjust the target BLER to obtain the modified target BLER, the grand outer loop of the network node 200 may perform the following process:

```
- Execution:
  - At the end of every N consecutive TTIs
    - If at least one TTI does not have PCH blocking:
      - ModifiedTargetBLER:= TargetBLER − downStep
    - Else (e.g., there is PDxCH blocking in all N consecutive TTIs, etc.)
      - ModifiedTargetBLER:= BLER + upStep
  - Return: ModifiedTargetBLER:= min(max(BLER,
  minBLER), maxBLER)
```

Where:
MaxBLER: a configurable parameter specifying a maximum modified target BLER
MinBLER: a configurable parameter specifying a minimum modified target BLER.
downStep: a configurable parameter specifying the amount of decrease in BLER target
upStep: the amount of increase in BLER target given by:

$$\\ \begin{matrix}upStep = \frac{1 - pdxchBlockingProb}{pdxchBlockingProb} \times downStep & ( 1 )\end{matrix}$$

PCHBlockingProb: configurable parameter that specifies a maximum PCH blocking probability.

As described at step 304, the grand outer loop of the network node 200 may update the BLER target at the end of scheduling N consecutive TTIs and use the scheduling outcomes to decide whether to increase the target BLER or decrease the target BLER to obtain the modified target BLER. Over a plurality of update iterations, for a sufficiently small value of downStep, the process performed by the grand outer loop generally results in a PCH blocking probability that is less than or equal to the PCHBlockingProb.

In one embodiment, to adjust the target BLER used for link adaptation for the plurality of WCDs to obtain the modified BLER at step 304, the network node 200, optionally, adjusts the target BLER of every TTI of the plurality of TTIs. For example, the grand outer loop of the network node 200 may adjust the target BLER in a sliding window manner, where the grand outer loop adjusts the target BLER every TTI utilizing the results of the current TTI and previous N−1 TTIs if N>1. Alternatively, in one embodiment, the grand outer loop of the network node 200 may adjust the target BLER in a discrete window manner, where the grand outer loop updates the BLER target every N TTIs.

In one embodiment, the network node 200 classifies subsets of the plurality of WCDs served by the cell into multiple M priority classes based on WCD characteristics (e.g., subscription package(s) associated with user(s) of the WCDs, WCD traffic bearers, WCD Quality of Service (QoS) requirements, etc.). Additionally, or alternatively, in one embodiment, the network node 200 may classify subsets of the plurality of WCDs served by the cell into multiple M classes based on associated channel conditions (e.g., based on WCD-reported CQI, connection information, etc.).

In one embodiment, the network node 200 can adjust the target BLER M times for the M subsets of WCDs of the plurality of WCDs. In one embodiment, the grand outer loop applies the previously described process M times using specific parameter values (e.g., PCHBlockingProb, downStep, minBLER, maxBLER, etc.), for each of the M subsets of WCDs, and define whether PCH blocking has occurred in a different manner for each of the M subsets of WCDs. For example, a higher priority subset of the M subsets of WCDs may have a lower PCHBlockingProb than a lower priority subset of the M subsets of WCDs. For another example, a WCD subset in a cell-edge WCD may have a different PCHBlockingProb than a WCD subset in a cell-center.

At step 310, the network node 200, optionally, performs link adaptation with a corresponding outer loop for a particular PCH transmission on the cell to a particular WCD of the plurality of WCDs served by the cell based at least in part on the modified target BLER. At step 312, to perform the link adaptation at step 310, the network node 200, optionally, adjusts a modulation or coding scheme or a transmission power of the PCH transmission on the cell to the particular WCD based on the modified target BLER.

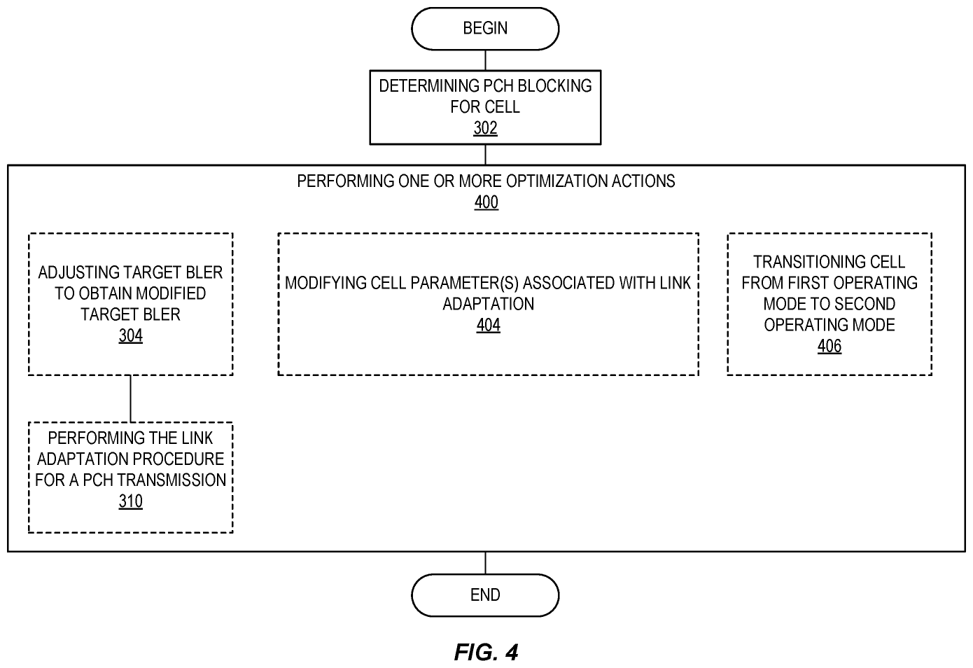

FIG. 4 is a flowchart illustrating a method for a network node to perform one or more optimization actions according to some embodiments of the present disclosure. Optional steps are represented in FIG. 4 by dashed lines/boxes. In this example, the network node is the network node 200. As illustrated, at step 302, the network node 200 determines whether PCH blocking has occurred for a plurality of consecutive TTIs as previously described with regards to FIG. 3.

At step 400, the network node 200 performs one or more optimization actions based at least in part on whether PCH blocking occurred as determined at step 302.

At step 304, to perform the one or more optimization actions, the network node 200, optionally, adjusts the target BLER to obtain the modified target BLER, and at step 310, optionally, performs the link adaptation procedure for a PCH transmission as described with regards to FIG. 3.

At step 404, to perform the one or more optimization actions, the network node 200, optionally, modifies one or more parameters associated with link adaptation. In one embodiment, the one or more parameters include one or more input parameters. Input parameter(s) include, or are otherwise associated with, inputs for link adaptation function (e.g., a CQI parameter, a RI parameter, etc.).

In one embodiment, the one or more parameters include one or more internal parameters. The internal parameter(s) are parameters included within, and/or associated with the functionality of, link adaptation (e.g., an estimated SNR, an estimated SNR generation function, etc.). As an example, link adaptation may internally generate an estimated SNR parameter (e.g., as an intermediate step, etc.). The estimated SNR parameter may be adjusted by applying an offset to the estimated SNR parameter.

In one embodiment, the one or more parameters include output parameter(s). The output parameter(s) are output(s) of link adaptation and/or are associated with the outputs of link adaptation (e.g., a decision output, a number of CCEs allocated to PDCCH resources of the PCH resources, etc.). For example, the output parameter(s) can include a CCE/PDCCH mapping that maps a certain quantity of CCEs allocated to each PDCCH resource.

At step 406, to perform the one or more optimization actions, the network node 200, optionally, transitions the cell controlled by the network node 200 from a first operating mode to a second operating mode based at least in part on whether PCH blocking occurred as determined at step 302. As an example, the operating modes 213 may include a first mode for a level of network congestion that is at or below a low congestion threshold, and a second mode for level of network congestion at or above a high congestion threshold. Each of the operating modes 213 map a number of PCH resources to a WCD for a quantity of bits to be transmitted. For example, the first operating mode may map 4 PCH resources to a WCD for transmitting a quantity of bits, and the second operating mode may map 2 PCH resources to a WCD for transmitting the same quantity of bits.

At step 408, to perform the one or more optimization actions, the network node 200, optionally, adjusts a number of CCEs allocated to PDCCH resources based at least in part on whether PCH blocking occurred as determined at step 302. As an example, the operating modes may include a first mode for a level of network congestion that is at or below a low congestion threshold, and a second mode for level of network congestion at or above a high congestion threshold. Each of the operating modes map a number of PCH resources to a WCD for a quantity of bits to be transmitted. For example, the first operating mode may map 4 PCH resources to a WCD for transmitting a quantity of bits, and the second operating mode may map 2 PCH resources to a WCD for transmitting the same quantity of bits.

It should be noted that by performing the one or more optimization actions at step 400, the network node 200 can perform any of the steps 304, 310, 404, and/or 406. More specifically, each of the aforementioned steps are optimization action(s) that a grand outer loop of the network node 200 may perform. Additionally, in some embodiments, PCH blocking may be mapped to various optimization action(s) using several ways known in control theory. For example, if the optimization actions are expressed as discrete/continuous steps between aggressive and conservative, then a feedback loop between PCH blocking and those actions can be created. For example, a simple proportional feedback loop can be utilized in which the optimization action taken is a direct function of PCH blocking (e.g., the BLER target is f(PCH blocking), where f is some deterministic function (e.g., 2*blocking probability), etc.).

As another example, if the optimization action(s) are discrete, then the action(s) can be associated directly from the PCHBlockingProbability parameter, with different values having different thresholds. For example, if the blocking is above some threshold Y, then mode 2 is used, otherwise mode 1 is used. As yet another example, the values of PCH blocking can be modified as well before they are applied to the optimization action. For instance, integral, sliding window, differentiation, and/or other multiple-time-instance function(s) can be applied to the PCH blocking value. For example, a PID controller could be used to drive PCH blocking to a target value.

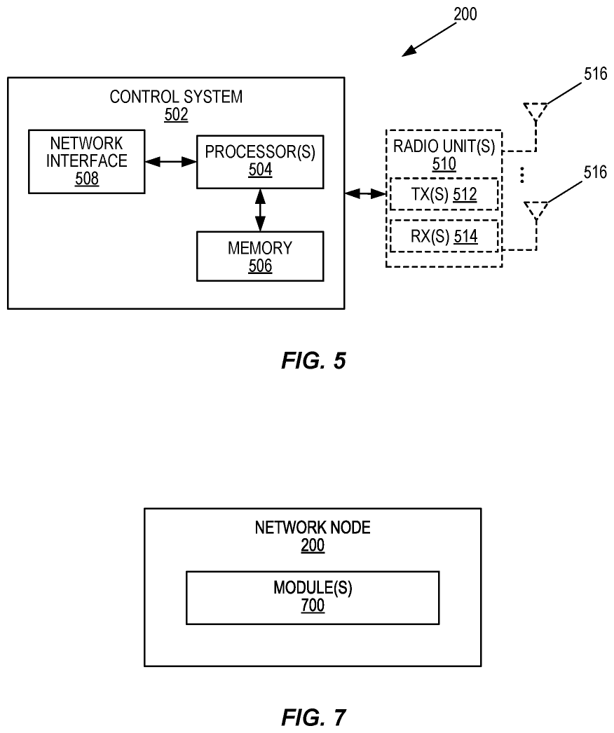

FIG. 5 is a schematic block diagram of a network node 200 according to some embodiments of the present disclosure. Optional features are represented by dashed boxes. The network node 200 may be, for example, a base station 102 or a network node that implements all or part of the functionality of the base station 102 or gNB described herein. As illustrated, the network node 200 includes a control system 502 that includes one or more processors 504 (e.g., Central Processing Units (CPUs), Application Specific Integrated Circuits (ASICs), Field Programmable Gate Arrays (FPGAs), and/or the like), memory 506, and a network interface 508. The one or more processors 504 are also referred to herein as processing circuitry. In addition, the network node 200 may include one or more radio units 510 that each includes one or more transmitters 512 and one or more receivers 514 coupled to one or more antennas 516. The radio units 510 may be referred to or be part of radio interface circuitry. In some embodiments, the radio unit(s) 510 is external to the control system 502 and connected to the control system 502 via, e.g., a wired connection (e.g., an optical cable). However, in some other embodiments, the radio unit(s) 510 and potentially the antenna(s) 516 are integrated together with the control system 502. The one or more processors 504 operate to provide one or more functions of a network node 200 as described herein. In some embodiments, the function(s) are implemented in software that is stored, e.g., in the memory 506 and executed by the one or more processors 504.

In some embodiments, the function(s) implemented or otherwise provided by the network node 200 include the function(s) as described with regards to FIG. 2. As an example, the network node 200 can implement or otherwise provide the grand outer loop 204, outer loop(s) 208, blocking determination function 217, and/or link adaptation function(s) 210 of FIG. 2 using the processor(s) 504 and/or memory 506 of the network node 200.

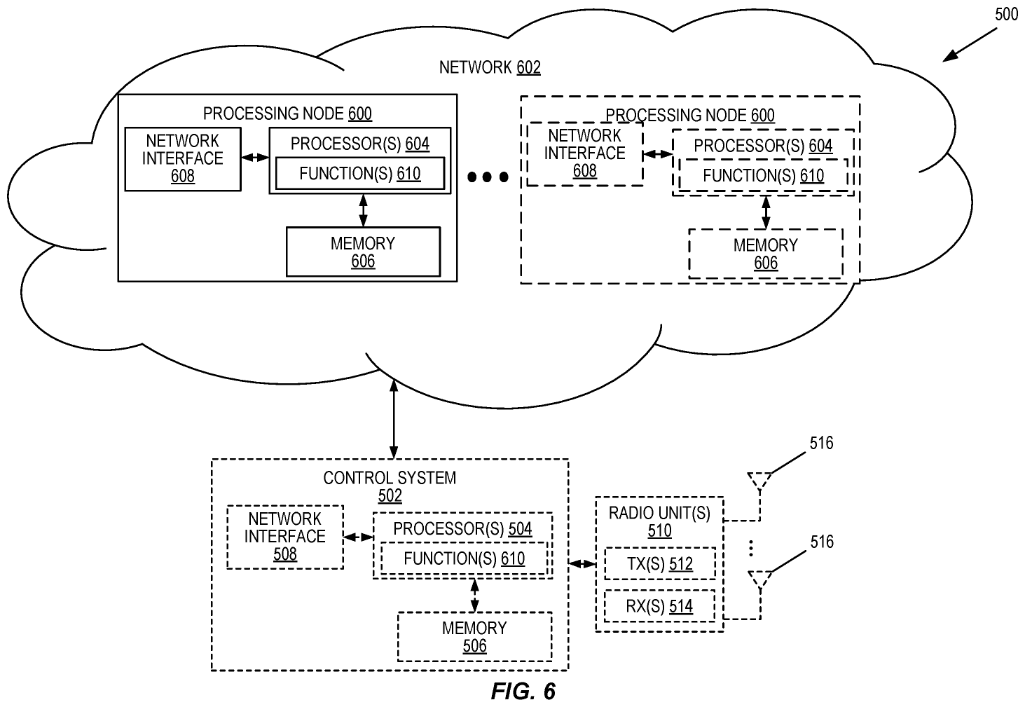

FIG. 6 is a schematic block diagram that illustrates a virtualized embodiment of the network node 200 according to some embodiments of the present disclosure. This discussion is equally applicable to other types of network nodes. Further, other types of network nodes may have similar virtualized architectures. Again, optional features are represented by dashed boxes.

As used herein, a “virtualized” radio access node is an implementation of the network node 200 in which at least a portion of the functionality of the network node 200 is implemented as a virtual component(s) (e.g., via a virtual machine(s) executing on a physical processing node(s) in a network(s)). As illustrated, in this example, the network node 200 may include the control system 502 and/or the one or more radio units 510, as described above. The control system 502 may be connected to the radio unit(s) 510 via, for example, an optical cable or the like. The network node 200 includes one or more processing nodes 600 coupled to or included as part of a network(s) 602. If present, the control system 502 or the radio unit(s) are connected to the processing node(s) 600 via the network 602. Each processing node 600 includes one or more processors 604 (e.g., CPUs, ASICs, FPGAs, and/or the like), memory 606, and a network interface 608.

In this example, functions 610 of the network node 200 described herein are implemented at the one or more processing nodes 600 or distributed across the one or more processing nodes 600 and the control system 502 and/or the radio unit(s) 510 in any desired manner. In some particular embodiments, some or all of the functions 610 of the network node 200 described herein are implemented as virtual components executed by one or more virtual machines implemented in a virtual environment(s) hosted by the processing node(s) 600. As will be appreciated by one of ordinary skill in the art, additional signaling or communication between the processing node(s) 600 and the control system 502 is used in order to carry out at least some of the desired functions 610. Notably, in some embodiments, the control system 502 may not be included, in which case the radio unit(s) 510 communicate directly with the processing node(s) 600 via an appropriate network interface(s).

In some embodiments, a computer program including instructions which, when executed by at least one processor, causes the at least one processor to carry out the functionality of network node 200 or a node (e.g., a processing node 600) implementing one or more of the functions 610 of the network node 200 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 7 is a schematic block diagram of the network node 200 according to some other embodiments of the present disclosure. The network node 200 includes one or more modules 700, each of which is implemented in software. The module(s) 700 provide the functionality of the network node 200 described herein. This discussion is equally applicable to the processing node 600 of FIG. 6 where the modules 700 may be implemented at one of the processing nodes 600 or distributed across multiple processing nodes 600 and/or distributed across the processing node(s) 600 and the control system 502.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

At least some of the following abbreviations may be used in this disclosure. If there is an inconsistency between abbreviations, preference should be given to how it is used above. If listed multiple times below, the first listing should be preferred over any subsequent listing(s).
3GPP Third Generation Partnership Project
5G Fifth Generation
5GC Fifth Generation Core
5GS Fifth Generation System
ACK Acknowledgment
AMF Access and Mobility Function
ASIC Application Specific Integrated Circuit
AUSF Authentication Server Function
BLER Block Error Rate
CCE Control Channel Element
CQI Channel Quality Indicator
CPU Central Processing Unit
CRC Cyclic Redundancy Check
DCI Downlink Control Information
DSP Digital Signal Processor
eNB Enhanced or Evolved Node B
EPC Evolved Packet Core
EPS Evolved Packet System
E-UTRAN Evolved Universal Terrestrial Radio Access Network
FPGA Field Programmable Gate Array
gNB New Radio Base Station
gNB-DU New Radio Base Station Distributed Unit
HARQ Hybrid Automatic Repeat Request
HSS Home Subscriber Server
IoT Internet of Things
LA Link Adaptation
LTE Long Term Evolution
MAC Medium Access Control
MME Mobility Management Entity
MTC Machine Type Communication
NACK Negative Acknowledgment
NEF Network Exposure Function
NF Network Function
NG-RAN Next Generation Radio Access Network
NR New Radio
NRF Network Function Repository Function
NSSF Network Slice Selection Function
P-GW Packet Data Network Gateway
PC Personal Computer
PCF Policy Control Function
PCH Physical Channel
PDCCH Physical Downlink Control Channel
PDSCH Physical Downlink Shared Channel
PID Proportional Integral Derivative
PUSCH Physical Uplink Shared Channel
PUCCH Physical Uplink Control Channel
PRS Positioning Reference Signal
QoS Quality of Service
RAM Random Access Memory
RAN Radio Access Network
ROM Read Only Memory
RI Rank Indicator
RP Reception Point
RRH Remote Radio Head
SCEF Service Capability Exposure Function
SMF Session Management Function
SNR Signal-to-Noise Ratio
TCI Transmission Configuration Indicator
TP Transmission Point
TRP Transmission/Reception Point
TTI Transmission Time Interval
UDM Unified Data Management
UE User Equipment
UPF User Plane Function
WCD Wireless Communications Device

Those skilled in the art will recognize improvements and modifications to the embodiments of the present disclosure. All such improvements and modifications are considered within the scope of the concepts disclosed herein.

1. A method performed by a network node for dynamic adjustment of a target Block Error Rate (BLER), the method comprising:
determining whether a Physical Channel (PCH) blocking has occurred for a plurality of consecutive Transmission Time Intervals (TTIs) on a cell controlled by the network node, wherein the PCH blocking occurs when one or more Wireless Communication Devices (WCDs) served by the cell cannot be scheduled for transmission in the cell due to unavailability of PCH resources in one or more consecutive TTIs; and
adjusting a target BLER for link adaptation for a plurality of WCDs served by the cell based on whether PCH blocking has occurred for the plurality of consecutive TTIs on the cell to obtain a modified target BLER for link adaptation for the plurality of WCDs served by the cell.

2. The method of claim 1, wherein PCH blocking occurs when one or more WCDs served by the cell cannot be scheduled for transmission in the cell due to unavailability of PCH resources in a single TTI, and
wherein determining whether PCH blocking has occurred for the plurality of consecutive TTIs on the cell comprises determining whether PCH blocking has occurred for each TTI of the plurality of consecutive TTIs.

3. The method of claim 1, wherein PCH blocking occurs when one or more WCDs served by the cell cannot be scheduled for transmission in the cell due to unavailability of PCH resources in a particular set of PCH resources in a single TTI, and
wherein determining whether PCH blocking has occurred for the plurality of TTIs on the cell comprises determining whether PCH blocking has occurred for each TTI of the plurality of consecutive TTIs.

4. The method of claim 1, wherein
PCH blocking occurs when one or more WCDs served by the cell cannot be scheduled for transmission in the cell due to unavailability of PCH resources in N consecutive TTIs,
determining whether PCH blocking has occurred for the plurality of TTIs on the cell comprises determining whether PCH blocking has occurred for one or more sets of N consecutive TTIs from among the plurality of consecutive TTIs, and
N is an integer that is greater than or equal to 2.

5. The method of claim 1, wherein:
PCH blocking occurs when one or more WCDs served by the cell cannot be scheduled for transmission in the cell due to unavailability of PCH resources in a given set of PCH resources in N consecutive TTIs,
determining whether PCH blocking has occurred for the plurality of TTIs on the cell comprises determining whether PCH blocking has occurred for one or more sets of N consecutive TTIs from among the plurality of consecutive TTIs, and
N is an integer that is greater than or equal to 2.

6. The method of claim 1, wherein adjusting the target BLER used for link adaptation for the plurality of WCDs served by the cell comprises:
making a determination that PCH blocking has not occurred for at least one of the plurality of consecutive TTIs; and
responsive to making the determination, reducing the target BLER by a predetermined downstep value to obtain the modified target BLER.

7. The method of claim 1, wherein adjusting the target BLER used for link adaptation for the plurality of WCDs served by the cell comprises:
making a determination that PCH blocking has occurred in each of the plurality of consecutive TTIs; and
increasing the target BLER by an upstep value to obtain the modified target BLER.

8. The method of claim 1, wherein the modified target BLER is less than or equal to a maximum BLER and greater than or equal to a minimum BLER.

9. The method of claim 7, wherein, prior to increasing the BLER by the upstep value, the method further comprises determining the upstep value based at least in part on:
$$\\ \frac{1 - a maximum blocking probability}{the maximum blocking probability} \times a predetermined downstep value$$

10. The method of claim 1, wherein adjusting the target BLER used for link adaptation for the plurality of WCDs served by the cell comprises adjusting the target BLER every TTI of the plurality of TTIs.

11. The method of claim 1, wherein the method further comprises performing, based at least in part on the modified target BLER, link adaptation for a PCH transmission on the cell to a particular WCD of the plurality of WCDs served by the cell.

12. The method of claim 11, wherein performing the link adaptation for the PCH transmission on the cell to the particular WCD comprises:
adjusting at least one of a modulation or coding scheme or a transmission power of the PCH transmission on the cell to the particular WCD based on the modified target BLER.

13. The method of claim 1, wherein the PCH blocking is either a Physical Uplink Shared Channel (PUSCH) blocking, a Physical Downlink Control Channel (PDCCH) blocking, or a Physical Downlink Shared Channel (PDSCH) blocking.

14. The method of claim 1, wherein adjusting the BLER for the link adaptation for the plurality of WCDs further comprises modifying one or more parameters associated with link adaptation for the cell controlled by the network node.

15. The method of claim 14, wherein the one or more parameters comprise one or more input parameters, comprising:
a Channel Quality Indicator (CQI); and,
a Rank Indicator (RI).

16. The method of claim 14, wherein the one or more parameters comprise one or more internal parameters, comprising:
an estimated Signal-to-Noise Ratio (SNR); and,
an estimated SNR generation function.

17. The method of claim 14, wherein the one or more parameters comprise one or more output parameters, comprising:
a decision output; and
a number of Control Channel Elements (CCEs) allocated to Physical Downlink Control Channel (PDCCH) resources of the PCH resources.

18. The method of claim 1, further comprising:
transitioning the cell controlled by the network node from a first operating mode to a second operating mode, wherein the first operating mode comprises a first mapping that allocates a first number PCH resources for a number of bits to be transmitted, and wherein the second operating mode comprises a second mapping that allocates a second number of PCH resources for the number of bits to be transmitted different than the first number of PCH resources.

19. A network node for dynamic adjustment of a target Block Error Rate (BLER), the network node adapted to:
determine whether a Physical Channel (PCH) blocking has occurred for a plurality of consecutive Transmission Time Intervals (TTIs)s on a cell controlled by the network node, wherein PCH blocking occurs when one or more Wireless Communication Devices (WCDs) served by the cell cannot be scheduled for transmission in the cell due to unavailability of PCH resources in one or more consecutive TTIs; and
adjust a target BLER for link adaptation for a plurality of WCDs served by the cell based on whether PCH blocking has occurred for the plurality of consecutive TTIs on the cell to obtain a modified target BLER for link adaptation for the plurality of WCDs served by the cell.

20. (canceled)

21. A network node for dynamic adjustment of a target Block Error Rate (BLER), the network node comprising:
processing circuitry configured to cause the network node to:
determine whether a Physical Channel (PCH) blocking has occurred for a plurality of consecutive Transmission Time Intervals (TTIs) on a cell controlled by the network node, wherein PCH blocking occurs when one or more Wireless Communication Devices (WCDs) served by the cell cannot be scheduled for transmission in the cell due to unavailability of PCH resources in one or more consecutive TTIs; and
perform one or more optimization actions, wherein the one or more optimization actions comprises one or more of:
adjusting a target BLER for link adaptation for a plurality of WCDs served by the cell based on whether PCH blocking has occurred for the plurality of consecutive TTIs on the cell to obtain a modified target BLER for link adaptation for the plurality of WCDs served by the cell;
modifying one or more parameters associated with link adaptation for the cell controlled by the network node; or
transitioning the cell controlled by the network node from a first operating mode to a second operating mode, wherein the first operating mode comprises a first mapping that allocates a first number PCH resources for a number of bits to be transmitted, and wherein the second operating mode comprises a second mapping that allocates a second number of PCH resources for the number of bits to be transmitted different than the first number of PCH resources.

22-28. (canceled)
